(19) United States
(12) Patent Application Publication
(10) Pub. No.: US 2012/0130858 A1
(43) Pub. Date: May 24, 2012

(54) SYSTEM FOR SERVING A DYNAMICALLY RANKED LIST OF MOTOR VEHICLES

(75) Inventors: Alexander George Kiss, Lehi, UT (US); Scott Nelson Putnam, Lyle, WA (US)

(73) Assignee: MATTERHORN, LLC, Cheyenne, WY (US)

(21) Appl. No.: 12/951,842

(22) Filed: Nov. 22, 2010

(51) Int. Cl. G06Q 30/00; G06F 17/30

(52) U.S. Cl. 705/26.64; 707/723; 707/E17.108

(57) ABSTRACT

A system and method are described for collecting motor vehicle information and generating an individually ranked list from seller information, public databases and buyer inputs and behavior. The ranked list is dynamically generated and presents to the buyer a relevant result set from millions of non-relevant listings.

### BACKGROUND OF THE INVENTION

1. Field of the Invention

The present invention relates to systems used to find and process information from a plurality of sources, and more particularly, to systems that aggregate vehicle information from networked electronic devices and monitor user behavior to present a specific “result set”.

2. Description of the Related Art

Purchasing a vehicles is a complicated decision beset with higher risks than the purchase of many other products. High dollar amounts and complex variables make a vehicle purchase a carefully researched and considered decision. Increasingly, consumers are using the information available on the internet to improve their purchasing decisions, often without ever testing-driving the vehicle.

Traditionally, a buyer obtains information about vehicles from advertisements, friends and visits to local dealerships. The rise of the internet in recent years has turned this conventional model on its head however, and gives the buyer the ability to ask very detailed questions and search through a larger pool of available vehicles.

Buyers often rely on brand information and “trusted” vehicle websites to gather information. However, these trusted websites almost never know the individual preferences of the user and have no reasonable means to compare the complex options and variables inherent in each vehicle listing.

These vehicle websites are designed for sellers to list vehicles, not for buyers to search through millions of listings. Most vehicle websites present results in a predetermined format tailored for the seller's promotion, not the buyer research activity. While a buyer may sort column headers or search on specific keywords, the tools are totally inadequate for searching through millions of vehicle listings. Often a buyer must manually sort through a long list vehicle results and repeat the search across multiple websites.

### SUMMARY OF THE INVENTION

The following is the outline of the present invention. A method and apparatus are provided for a dynamic information connection and processing engine wherein user initiated search results are collected and abstracted using a computer system and/or a computer network and algorithmically ranked based upon compiled user information and market variables. According to certain embodiments of the present invention, the search query result set is presented to the user in a ranked format called the result set.

In a traditional vehicle listing retrieval paradigm, the retrieval problem is to match a query with a subset of vehicles in inventory and present such vehicles according to the user's preferences. When inventories were limited to hundreds of vehicles, it was easy to limit the result set to a few vehicles. Today, there are literally millions of vehicles for sale every day. Autotrader, Vast, Trovit, Autoscout24 are examples of popular internet vehicle listing aggregators, and all of them allow for simple keyword searching on their inventory; often providing hits of over 1000 vehicles per search. But this search result set is suboptimal from the perspective of the buyer. An example of this may be a supplier paying a fee for their search result data to be listed “higher” than other more relevant search results. Frequently, vehicles listed lower are on the list are never viewed because the large number of search results. In another example, a red car maybe listed on the site as “burgundy” and never be visible to the user requesting a “red” car. The aggregation and keyword search display logic do not take into account contextual and user information, resulting in an inefficient and ineffective search for a buyer.

Thus a buyer utilizes embodiments of the present invention to tailor specific vehicle search parameters via a graphical user interface (GUI) and a set of automated calculations. A plurality of economic indicators and feedback information from the user, both implicit and explicit, is used to create an Algorithmic Market Indicator model (AMI). The AMI model is accessible to the user and may also be modified by the user to provide an effective search.

In one embodiment of my invention, the system runs a real-time set of economic calculations based upon the AMI to provide the user with a result set during his/her vehicle search query. For example, if gasoline prices continue to be volatile and suddenly increase, the AMI will place a greater weighting on the miles-per-gallon (mpg) rating of each vehicle, thus placing more fuel efficient vehicles closer to the top of the list, all other variables being equal. In another example, if the national unemployment rate (source: Bureau of Labor Statistics) remains at elevated levels relative to a 5 year average, the AMI will weigh the price of a vehicle higher as consumers will be sensitive to cost, thus placing vehicles with a lower cost closer to the top of the list, all other variables being equal.

In another embodiment, the system aggregates vehicle listings from a plurality of sources and processes the information into a commensurate list of standardized attributes for each vehicle. For example, a vehicle might be listed as “4WD” in one source and an alternative vehicle as “4×4” from another source, and “AWD” from a third source. While the attribute is the same on each vehicle, the semantic use is different for each supplier, and for each user. The system abstracts the core attributes of all vehicles and presents them in a semantic result set relevant to the user.

In another embodiment of my invention, the system aggregates vehicle listing information from a plurality of supplier sites, including wholesale auction sites and salvage houses. The system then breaks down this data in a hierarchical attribute list and creates a standardized schema of all data points available for query.

In another embodiment, the system collects user information entered directly by the user when creating a profile. Such explicit data such as age, sex, location, single/married, size of family, is collected by the system and used to infer the AMI model interests of the user. Once a profile is created, the system compiles that data to model its real-time search result set for each search. For example, if the user has entered a location of Buffalo, NY and a family size of five, the system would place vehicles that were 4×4 and had a greater passenger capacity closer to the top of the list, all other variables being equal.

In one embodiment, the system expands the user information model by inferring the user's intent based on information gathered by virtue of clicking on vehicles during a search. In another embodiment, other aspects of a users behavior, such as parameters entered during search query personalization, time spent looking at different vehicles in the result set, transactions, clicking on images, video or other information, are also monitored and used to infer and then model the intent and interests of the user.

In one embodiment, the system calculates the value a user places on each vehicle attribute or option as they edit an existing list by placing the most important options in a specific order, thus creating a weighted-model of the user's intent.

The outcome is a personalized vehicle search result set that intelligently incorporates new information regarding the market and/or the user's specific intent. The system not only exploits all of the intelligence and technology built into the underlying aggregation engine to generate the search pool, it uses a real-time modeling program to immediately return a result set. This processing technology by pooling from a plurality of sources was not available until recently due to advancements in technology. This system and method equips users with better tools to quickly find the exact car they are looking for.

### BRIEF DESCRIPTION OF THE DRAWINGS

The present invention will be more readily understood from the detailed description of exemplary embodiments presented below considered in conjunction with the attached drawings, of which:

FIG. 1 illustrates an exemplary system for abstracting vehicle listing information in a database, indexing said data and publishing to users, according to an embodiment of the present invention;

FIG. 2 illustrates an exemplary system for users accessing stored and indexed vehicle data across a communications network, according to an embodiment of the present invention;

FIG. 3 illustrates an exemplary system for aggregating vehicle information from a plurality of sources and storing vehicle data in a central database, according to an embodiment of the present invention;

FIG. 4 illustrates an exemplary method for a user to search on the website and view ranked results based upon their site usage and modification history, according to an embodiment of the present invention;

FIG. 5 illustrates an exemplary screenshot showing the Home or Search page, according to an embodiment of the present invention;

FIG. 6 illustrates an exemplary screenshot showing the My Account page where a user can create and edit his personal search weight variable list, according to an embodiment of the present invention;

FIG. 7 illustrates an exemplary screenshot showing the AMI Weighting page where a user can modify the weighting of a list of predetermined variables, according to an embodiment of the present invention;

FIG. 8 illustrates an exemplary screenshot showing the ranked results of a search based upon the users personalized feedback, according to an embodiment of the present invention;

FIG. 9 illustrates an exemplary screenshot showing the re-ranked results of a search based upon the users personalized and behavioral feedback, according to an embodiment of the present invention;

FIG. 10 illustrates an exemplary architectural diagram for hosting the vehicle search website on a distributed cloud environment, according to an embodiment of the present invention;

### DETAILED DESCRIPTION OF EMBODIMENTS OF THE INVENTION

In the following detailed description, reference is made to the accompanying drawings which form a part hereof, and in which is shown by way of illustration, embodiments of my invention. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent. The description may use perspective-based descriptions such as up/down, back/front and top/bottom. Such descriptions are merely used to facilitate the discussion and are not intended to restrict the application of embodiments of the present invention.

The description may use phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

In various embodiments of the present invention, methods, apparatuses and systems for providing purchasers of vehicles the ability to efficiently search through vehicle listing data by using the collective intelligence of database abstracting and real time user customization.

Embodiments of the present invention allow purchasers of vehicles to obtain relevant search results for vehicles that match their personal interests.

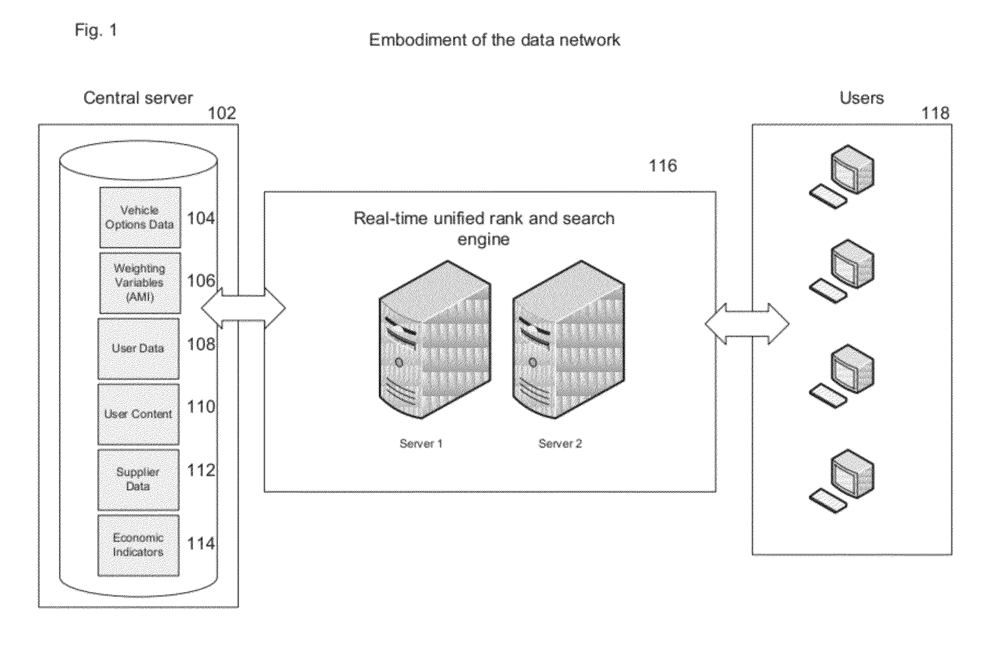

FIG. 1 illustrates a data network according to an embodiment of the present invention and demonstrates how data in a central server 102 may be used to deliver highly relevant vehicle search results to users 118. As illustrated in FIG. 1, the data network includes a central server 102, dual intelligent search engine servers 116 and a plurality of users 118. According to an embodiment of the present invention, the central server 102 holds such relevant information such as data about vehicle options data 104 (manual/automatic, leather seats, power windows etc.), an Algorithmic Market Indicator model (AMI) 106, user data 108 (location, age, preferences etc.), content provided by users 110 (search history, search weighting, click data etc.), supplier data 112 (vehicle listing data, descriptions, photos, links etc.) and economic indicators 114 (national unemployment rate, inflation rate, average price of unleaded fuel etc.). The data is parsed and abstracted by the search engine 116 to deliver relevant results to users 118. The tailored search results shown to the different users 118 may depend on the plurality of customized variables entered into or obtained by the central server 102 by the user. This way it is possible for the system to target a plurality of users 118 individually and for each individual user to have different, customized search results for the same search query. The term “computer” is intended to include any data processing device, such as a desktop computer, a laptop computer, a mainframe computer, a personal digital assistant, a server, a handheld device, or any other device able to process data. The aforementioned components of FIG. 1 and the central server 102 represent computer hardware and/or computer-implemented software modules configured to perform the functions described in detail below. One having ordinary skill in the art will appreciate that the components FIG. 1 may be implemented on one or more communicatively connected computers. The term “communicatively connected” is intended to include, but is not limited to, any type of connection, whether wired or wireless, in which data may be communicated, including, for example, a connection between devices and/or programs within a single computer or between devices and/or programs on separate computers.

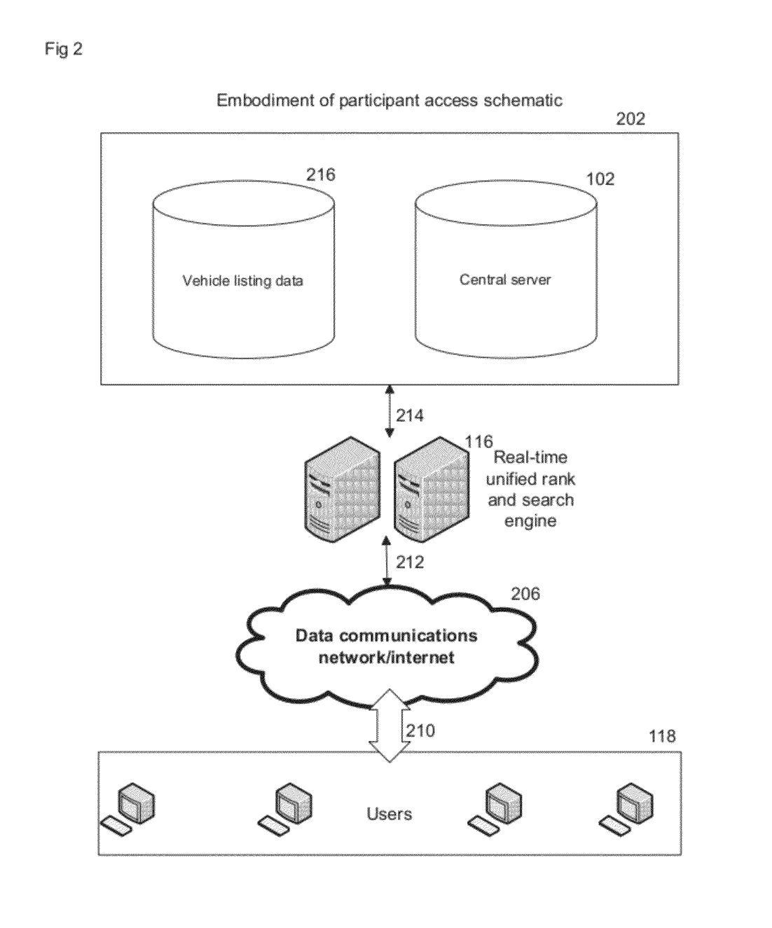

The features and functionality of embodiments of the central server 102 and its components are described in detail in connection with the system diagram of FIG. 1 and the participant access schematic of FIG. 2. As illustrated in FIG. 1 the user is communicatively connected to the central server 102 via the intelligent search engine servers 116. In operation, FIG. 2 shows users 118 on computers or terminals seeking information can connect with our service on a data communications network 206, such as the internet, across a secure (https:) or unsecure (http:) connection 210. Once connected to the rank and search engine servers 116 via a secure connection 212, the user can modify his/her vehicle search parameters along with rank weighting and begin their keyword vehicle search which will return results sorted and ranked by an algorithm that places the ones with the highest probability of being relevant to the user's query at the top. An embodiment of the present invention provides a database 202 consisting of a vehicle database 216 and a central server 102 which aggregate and abstract the vehicle listing data in preparation for parsing by the rank and search engine across a secure connection 214.

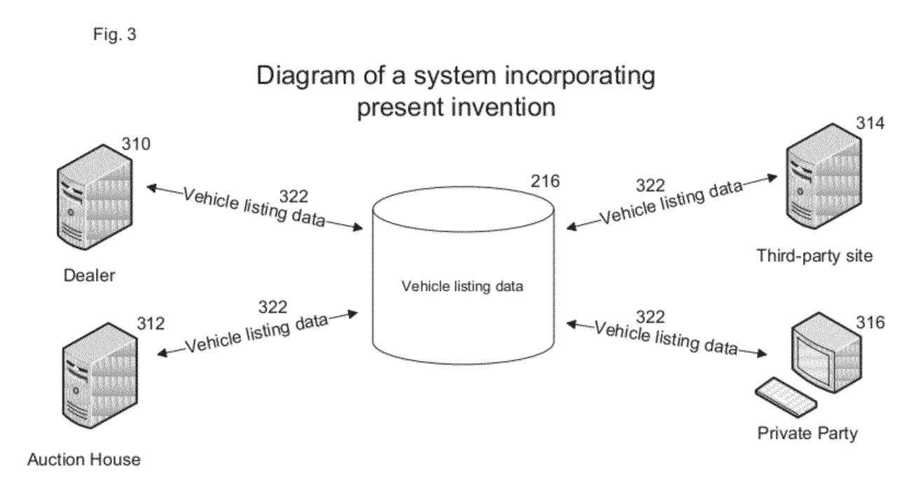

For a better understanding of the embodiments of the present invention, FIG. 3 provides an example of a plurality of data suppliers which feed data across secure (https:) or unsecure (http:) connections 322 to the vehicle listing database 216. Vehicle information may come from a dealer 310 (Ford dealership, used car dealer etc.), an auction house 312 (Manheim, Adesa, salvage etc.), a third party site 314 (Vast, Trovit, Cars etc.) and a private party 316 (Craigslist, classifieds, direct listing etc.).

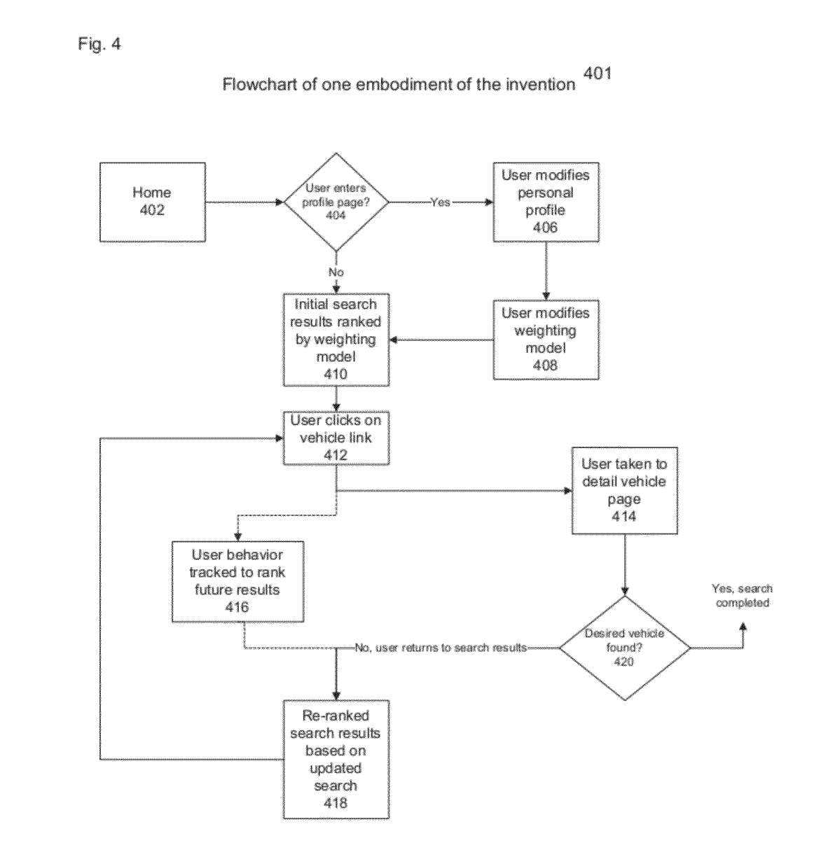

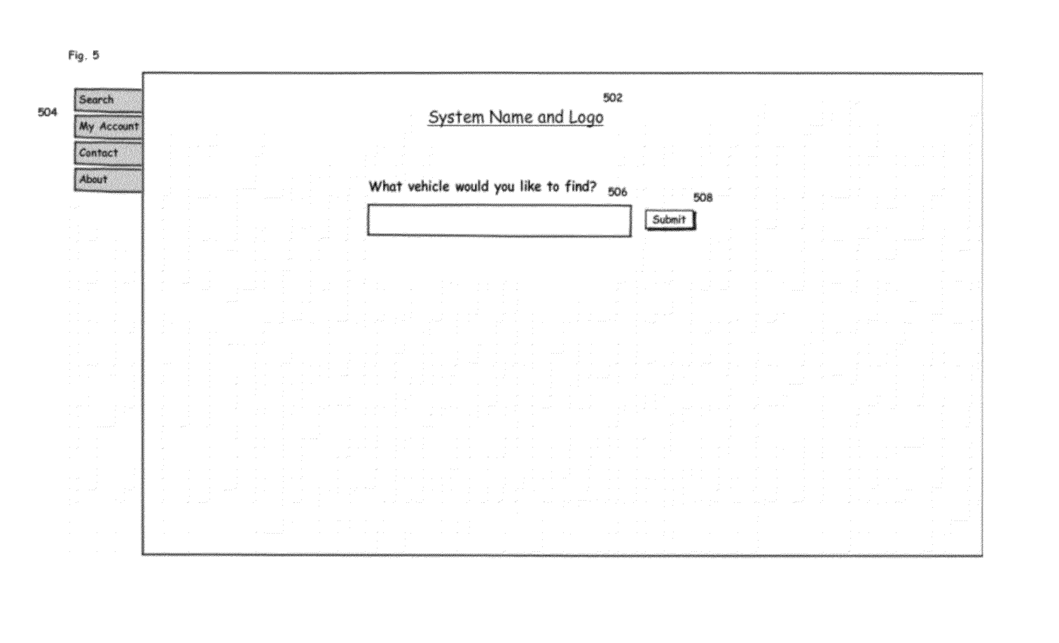

The process flow diagram of FIG. 4, 401, outlines one embodiment of my invention where a user accesses the home page at step 402 and is brought to the home page as illustrated by FIG. 5, a diagram of a home page of a preferred embodiment of my invention. Other links and information are present, but the principle purpose of the home page is to enable the user to enter a keyword or set of keywords in the search entry box 506 representing the user's vehicle query before clicking on the submit button 508 to request that the rank and search engine 116 retrieve the results. In one embodiment of my invention, the home page contains the system name and logo 502 across the top of the page while the left column contains tabs 504 which allow access to different areas of the system.

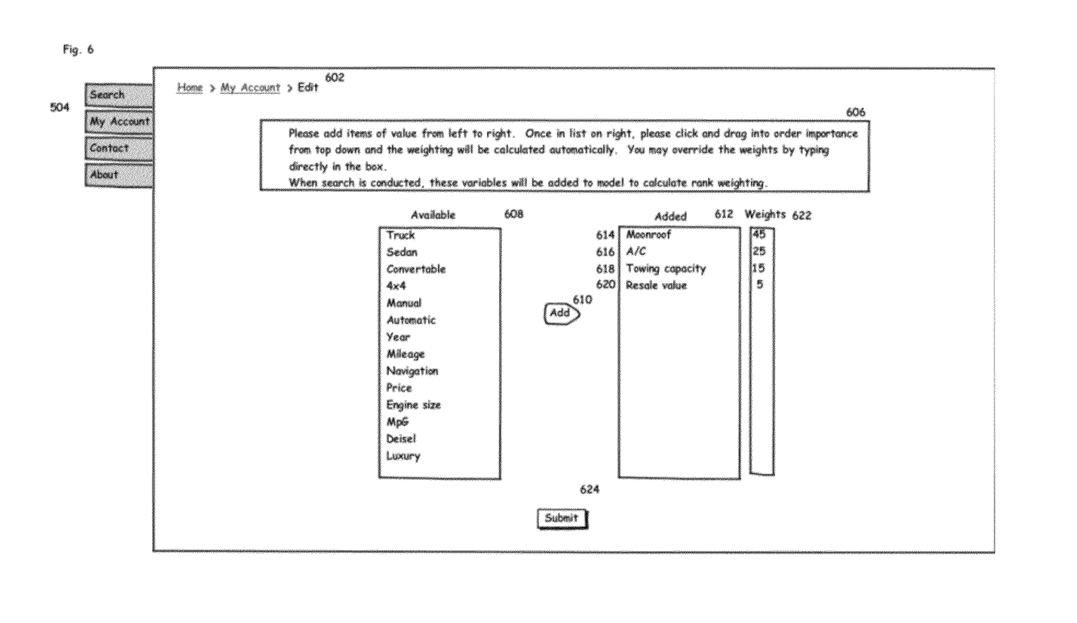

In one embodiment of my invention, following the home page the user 118 can navigate to the profile page at step 404 of FIG. 4 where they can register on the system by providing personal details and then enter the account page illustrated in FIG. 6. In step 406 of FIG. 4, the user 118 modifies his/her personal vehicle option profile as outlined 606 in FIG. 6. Listed are all available options 608 and the user can select each individual option and add 610 them to their customized list 612. In this example, the user has selected a moon-roof 614, air-conditioning 616, towing capacity 618 and resale value 620 as their most highly weighted 622 search criteria in order from top to bottom when conducting a vehicle search query. The submit button 624 is selected which transmits the user data 108 to the central server 102. In one embodiment of my invention, the profile page contains tabs 504 which allow access to different areas of the system and the top left contains a breadcrumb trail 602 providing the user links back to each previous page the user has navigated from or the parent page of the current one.

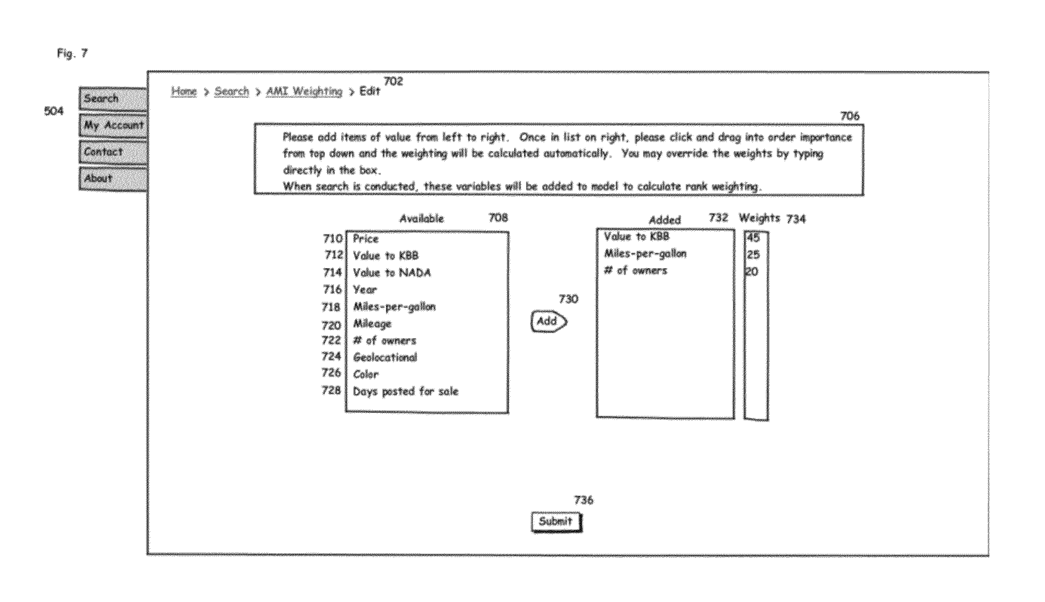

In one embodiment of my invention, in step 408 of FIG. 4, the user navigates to a list of market information in FIG. 7. Some items on the market list 708 are explicit attributes entered by the seller 710, 720, some are features referenced from public sources 716, 718, and some are calculated by the system 712, 714, 724. In one embodiment of my invention, the market weighting variable list 734 is modeled through a normalization function created directly from aggregate user behavior. The user is able to re-order the market weighting variable list 734 to tailor the vehicle search query results to their own weighting, overriding the system's calculated weighting. In this example, the user has edited the list by clicking and dragging variables to a final outcome 732 where value to KBB 712 holds the most weight and the subsequent variables each hold less weight in the search query calculation than the one preceding. The submit button 736 is selected which transmits the user data 108 to the central server 102. In one embodiment of my invention, the profile page contains tabs 504 which allow access to different areas of the system and the top left contains a breadcrumb trail 702 providing the user links back to each previous page the user has navigated from or the parent page of the current one.

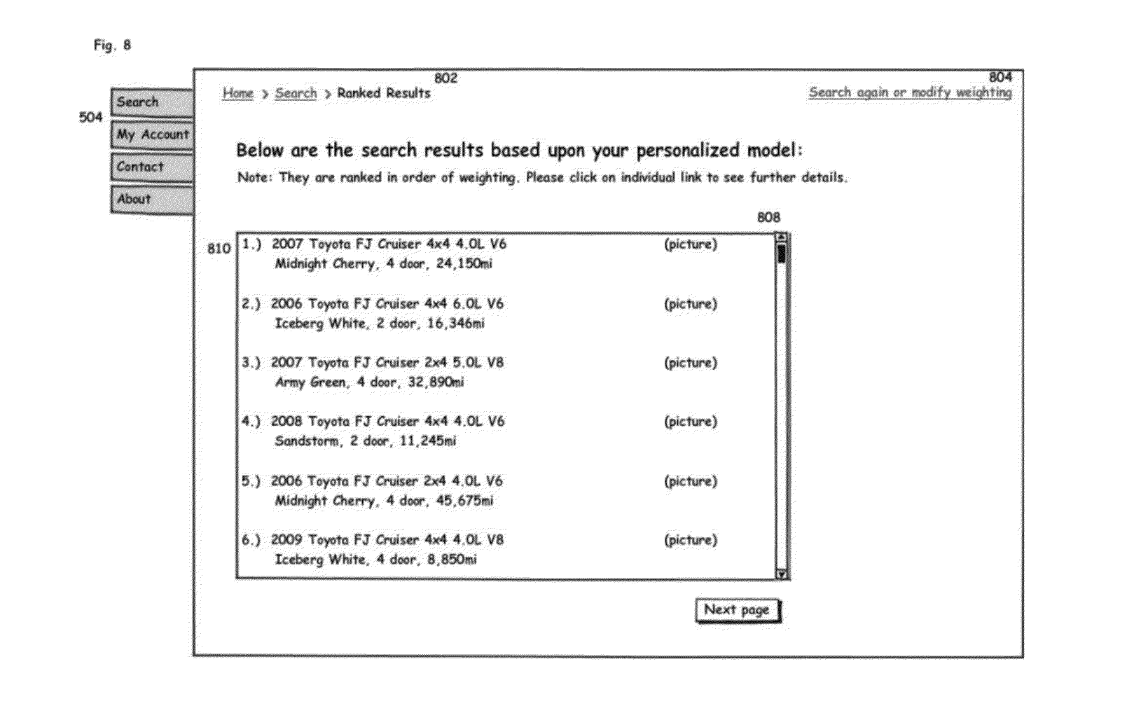

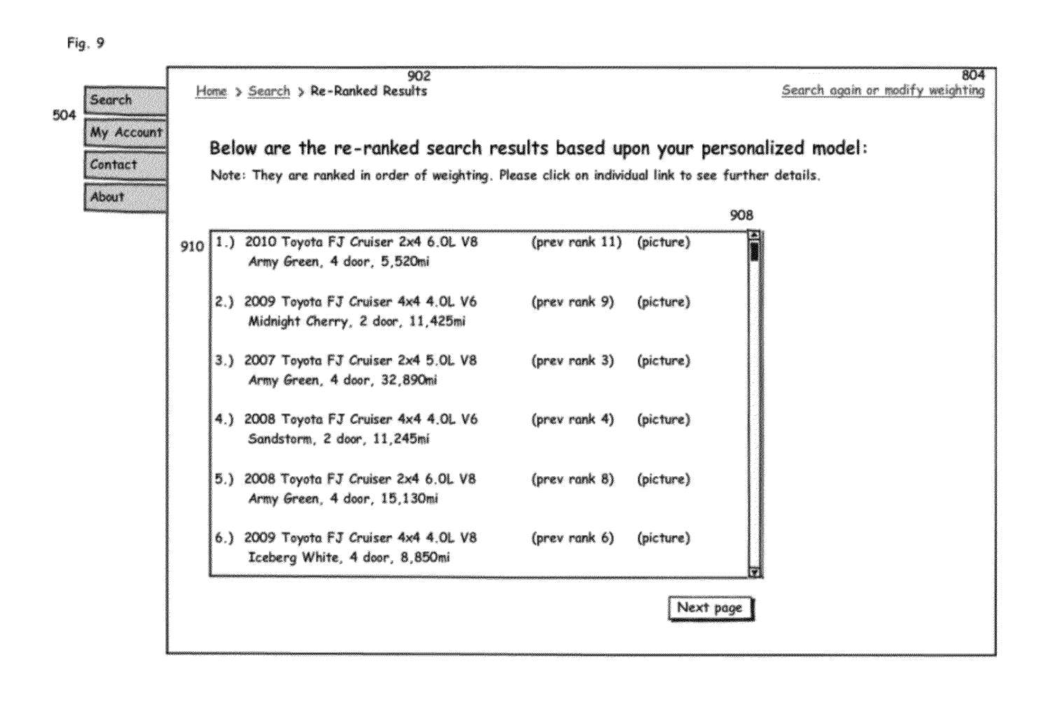

In one embodiment of my invention, in step 410 of FIG. 4, the user navigates to the search results page illustrated in FIG. 8. The set of search results 808 and its order is based upon the intelligence gathered by the central server 102, the weighting and modeling by the rank and search engine 116 and the users own personalized modifications. The system has determined that the user is most likely interested in the specific vehicle listing 810 resulting in its position at the top of the list. Each subsequent vehicle listing has a lower approximated value to the user than the preceding vehicle listing as determined by the system algorithm. In one embodiment, as illustrated in FIG. 9, every time the model is updated, the system re-ranks all of the vehicle search results according to the new data. As illustrated in FIG. 4, the user can navigate to the search results page, step 410, even though they did not modify their personal profile, step 406, or weighting model, step 408. In such a circumstance, the set of search results 808 in FIG. 8 will be computed based upon the preset weighting mechanism built into the system and also intelligence gathered by the central server 102. In one embodiment of my invention, if the user is not satisfied with the result set he/she can search again or modify search weighting by clicking on the link 804. The search results page contains tabs 504 which allow access to different areas of the system and the top left contains a breadcrumb trail 802 providing the user links back to each previous page the user has navigated from or the parent page of the current one.

In one embodiment of my invention, in step 412 of FIG. 4, the user selects a vehicle from the vehicle search result set 808 by clicking on the link 810. He/she is then taken to the detailed vehicle listing page, step 414, which provides all vehicle listing information abstracted by the central server 102 and reformatted into a contextual presentation. In the process of clicking on links, the system collects information regarding the user's behavior, step 416, in an effort to divine the user's intent and interests in order to adjust future search results accordingly and return a more customized search result set. Data regarding user behavior immediately following the initial search comes from anything related to the activity of the user, including, but not limited to, clicks on various links, including advertisements, in the search results as well as subsequent clicks on links within detailed vehicle listings, skipped links in the search result, dwell times, times spent looking at detailed vehicle listings, resources accessed, purchases made, documents downloaded, cursors moved, pages scrolled or text, images or other information highlighted, or any combination thereof. In general, the more time spent looking at a specific detailed vehicle listing, the more relevant that vehicle and its variables are to the user.

In one embodiment of my invention, as illustrated in FIG. 9, while the detailed vehicle listing page is being reviewed, the system will simultaneously take information collected regarding the users behavior to re-rank the initial search results, step 418. If the user finds the desired vehicle, step 420, on the first try, then the search is satisfied and the process completed. However, should the user return to the vehicle search results page, FIG. 9, the new vehicle search result set 908, having been re-ranked while the user was away, will be displayed. He/she can then select a specific vehicle listing 910 to see the details and the process described above is repeated. At any point in the search, the user is able to modify keywords, personal vehicle search profile, FIG. 6, and/or modify the market weighting, FIG. 7.

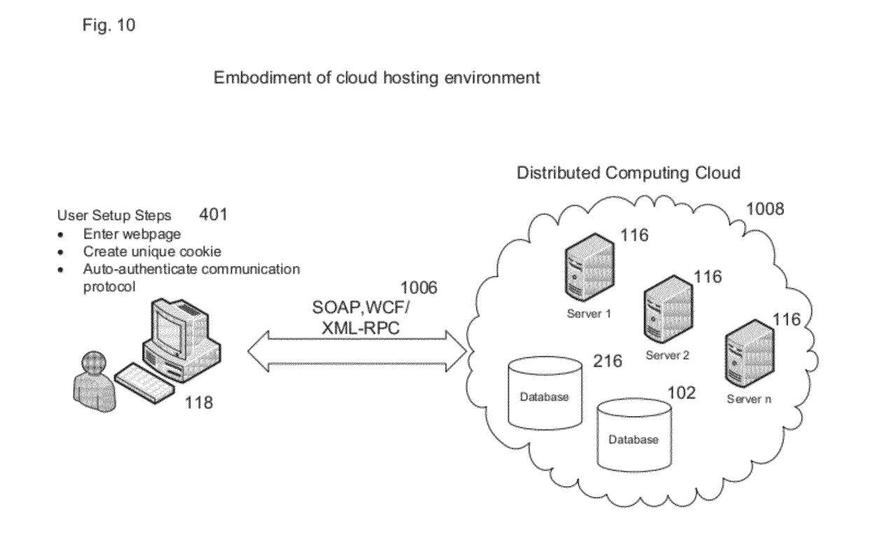

There are multiple solutions to hosting the system and FIG. 10 illustrates an example of cloud or distributed hosting environment 1008. In one embodiment of my invention, the databases 102, 216 are distributed across a plurality of mirrored computer resources such that there is not a single master database. The servers 116 are also distributed across a plurality of mirrored computer resources such that there is not a single master server for the system. A user 118 enters the system through an electronic device connected to the internet and the user setup step sequence 401 is initiated. This electronic device communicates with the servers 116 through defined protocols 1006, including but not limited to SOAP, XML, WCF and RPC.

Although certain embodiments have been illustrated and described herein for purposes of description of the preferred embodiment, it will appreciated by those of ordinary skill in the art that a wide variety of alternate and/or equivalent embodiments or implementations calculated to achieve the same purposes may be substituted for the embodiments shown and described without departing from the scope of the present invention. Those with skill in the art with readily appreciate that the embodiments in accordance with the present invention may be implemented in a very wide variety of ways. This application is intended to cover and adaptations or variations of the embodiments discussed herein. Therefore, it is manifestly intended that embodiments in accordance with the present invention be limited only by the claims and the equivalents thereof.

What is claimed is:

1. A computer implemented method for dynamically generating customized vehicle search result set, comprising:
receiving one or more keywords for use as search terms from a user;
receiving in database key economic indicators;
generating a customized vehicle search result set by calculation based on economic indicators and at least one of the keyword terms.

2. The method of claim 1, wherein said customized vehicle search result set is presented in a ranked list based on calculated value to the user.

3. The method of claim 1, wherein said key economic indicators comprises, but is not limited to, national unemployment rate, national inflation rate, national average price of unleaded fuel, daily average price of crude oil, international foreign exchange rates, wholesale used vehicle prices and federal miles per gallon rating on specific vehicle.

4. A method for receiving in a database vehicle information data from third party providers and abstracting said data into its component parts, whereby a human could enter semantically similar keyword search terms which the search engine would recognize as one.

5. A method of claim 4, further comprising providing a user interface allowing a user to rank in order of personal importance said vehicle component parts such that they have a higher weighting during generation of a customized vehicle search result set.

6. The method of claim 1, wherein said economic indicators are entered into a search engine software program and combined with said vehicle data from suppliers to generate said customized vehicle search result set in a ranked list.

7. A system for monitoring by server user behavior to include at least one of:
clicks on links in the search results;
subsequent clicks on links within any attached documents;
dwelling time;
resources accessed;
transactions conducted;
purchases made;
orders placed;
sessions created;
documents downloaded;
pages or text scrolled;
images viewed or other information highlighted.

8. The method of claim 2, further comprising some header and display suggestions to the user with each of said vehicle search result set objects in said first customized vehicle search result set to form a vehicle listing;
monitoring which of said objects is selected by said user;
using terms from the header and display text corresponding to selected object as data used to infer said user behavior and then model the intent and interests of said user to provide a second result set.

9. The method of claim 7, further comprising a filtering of the said vehicle search result set by associating attribute information in the selected listings to achieve a reduced and more relevant result set.

10. The method of claim 8 wherein said second search result set comprises a re-ranked version of at least a portion of said first vehicle search result set.

11. The method of claim 3, further comprising providing a user interface allowing a user to rank in order of personal importance select said key economic indicators by promoting said indicators such that they have a higher weighting during generation of said customized vehicle search result set.
